(19) United States
(12) Patent Application Publication
(10) Pub. No.: US 2023/0390622 A1
(43) Pub. Date: Dec. 7, 2023

(54) SPORTS TRAINING AID

(71) Applicant: PERFECT SHOT LIMITED, Pahiatua (NZ)

(72) Inventors: Joshua Charles TE RAUNA, Palmerston North (NZ); Gebe Peter REDDING, Palmerston North (NZ)

(21) Appl. No.: 18/033,298

(22) PCT Filed: Oct. 22, 2021
(86) PCT No.: PCT/NZ2021/050183

§ 371 Date: Apr. 21, 2023

(30) Foreign Application Priority Data
Oct. 23, 2020 (NZ) 769344

(51) Int. Cl. A63B 69/00; A63B 24/00; A63B 71/06

(52) U.S. Cl. CPC A63B 69/0071; A63B 24/0006; A63B 71/0619; A63B 2024/0009; A63B 2024/0015; A63B 2071/0638; A63B 2071/0666; A63B 2220/20; A63B 2220/806

(57) ABSTRACT

A method for providing an enhanced sports training experience comprising providing a user with a wearable near-eye display, capturing an image in a user's field of vision, detecting the presence of a basketball hoop in the image, the basketball hoop having an associated backboard, using an image processor to determine a three dimensional position of the hoop relative to the near-eye display, calculating an ideal trajectory between the user and the hoop, whereby a basketball following the trajectory will pass through the basketball hoop, determining the apex of the trajectory, and displaying on the near-eye display, a visual graphic at the trajectory apex, the visual graphic representing a target.

### FIELD OF THE INVENTION

This invention relates to a sports training aid, in particular an augmented reality or virtual reality training aid to assist a player with shooting a basketball into a hoop.

### BACKGROUND

Augmented reality and virtual reality technology is becoming more readily commercially available and accessible. This technology is most commonly employed for gaming purposes but has the potential for use to assist with sports training by providing real-time information and feedback to a player.

In the sport of basketball, players spend many years practising and refining the technique of shooting basketballs into a hoop. This is generally a process of trial and error, with the only feedback the athlete receives being whether the shot was successful or not. Some virtual reality systems exist in which a player can ‘shoot’ a virtual ball at a virtual basketball hoop. These systems may have sensors that need to be worn by the player to monitor movement of their arms and wrists, to model the predicted trajectory of the ball. These systems may offer some entertainment as games, but they are of little use as a sports training aid because the player does not shoot a real ball. Such virtual reality systems also do not accurately take into account the large number of varying styles different players may have for shooting a ball, or subtleties of movements, for example spin created by the ball on the fingers, or movement of the lower body, which can impact on the trajectory a real ball follows when released.

It is an object of at least preferred embodiments of the present invention to address one or more of the above mentioned disadvantages and/or to at least provide the public with a useful alternative.

In this specification where reference has been made to patent specifications, other external documents, or other sources of information, this is generally to provide a context for discussing features of the invention. Unless specifically stated otherwise, reference to such external documents or sources of information is not to be construed as an admission that such documents or such sources of information, in any jurisdiction, are prior art or form part of the common general knowledge in the art.

### SUMMARY OF THE INVENTION

According to a first aspect, the invention described herein broadly consists in a method for providing an enhanced sports training experience, comprising the steps of:
providing a user with a wearable near-eye display;
capturing an image in a user's field of vision;
detecting the presence of a basketball hoop in the image, the basketball hoop having an associated backboard;
using an image processor to determine a three dimensional position of the hoop relative to the near-eye display;
calculating an ideal trajectory between the user and the hoop, whereby a basketball following the trajectory will pass through the basketball hoop;
determining the apex of the trajectory; and
displaying on the near-eye display, a visual graphic at the trajectory apex, the visual graphic representing a target.

In an embodiment the basketball hoop comprises a backboard with a graphic pattern, and the step of detecting the presence of a basketball hoop comprises detecting the graphic pattern.

In an embodiment the step of determining the three dimensional position of the hoop comprises calculating the distance between the user and the hoop.

In an embodiment the ideal trajectory is a trajectory whereby a basketball following the trajectory will pass through the basketball hoop without touching the backboard or the hoop. The trajectory may be one calculated mathematically to optimise an aspect of the trajectory such as to minimise the trajectory length. Alternatively the trajectory may be calculated on a preferred or characteristic trajectory of the user or of another player, for example a professional player the user desires to emulate.

In an embodiment the visual graphic representing the target comprises a shape centred on the highest point of the trajectory. The shape may be displayed in a vertical plane. The shape may be a circle, in particular a ring. The shape is preferably displayed in a colour that has high colour contrast to the surroundings.

In an embodiment, the near-eye display comprises an augmented reality headset, and the image representing a target is overlaid on the user's field of vision. Alternatively, the near-eye display may comprise a virtual reality headset.

In an embodiment, the method comprises the step of displaying the trajectory on the near-eye display.

In an embodiment movement of the user is detected, and each time movement is detected, the ideal trajectory is recalculated and the target re-adjusted. For example, a camera may be provided to continuously capture an image in the user's field of vision, and each time the image changes, the ideal trajectory is recalculated and the target re-adjusted. Changes in the image between frames is indicative of movement of the user.

According to a second aspect, the invention described herein broadly consist in a personal near-eye display apparatus for use during a sporting activity, comprising: a camera for capturing an image in a user's field of vision; one or more processors having access to non-transitory memory and configured to execute software for detecting the presence of a basketball hoop in the image, the software being configured to determine a 3D position of the hoop, calculate an ideal trajectory between the user and the hoop, whereby a basketball following the trajectory will pass through the basketball hoop, and determine an apex of the trajectory; and a projector to display a graphic on the near-eye display at the trajectory apex, the visual graphic representing a target.

In an embodiment, the software is configured to detect a basketball hoop backboard that comprises a known graphic pattern. The software may be configured to calculate the distance between the user and the hoop.

In an embodiment, the ideal trajectory is a trajectory whereby a basketball following the trajectory will pass through the basketball hoop without touching the backboard or the hoop. The trajectory may be one calculated mathematically to optimise an aspect of the trajectory such as to minimise the trajectory length. Alternatively the trajectory may be calculated on a preferred or characteristic trajectory of the user or of another player, for example a professional player the user desires to emulate.

In an embodiment, the visual graphic representing the target comprises a shape centred on the highest point of the trajectory. Preferably the projector displays the shape in a vertical orientation. The shape may comprise a circle such as a ring, or other shape.

In an embodiment, the near-eye display comprises an augmented reality headset. Alternatively, the near-eye display may comprise a virtual reality headset.

In an embodiment, the camera is configured to continuously capture an image in a user's field of vision, and wherein the processor is configured to detect changes to the image and recalculate the ideal trajectory adjust the target when a change is detected.

According to a third aspect, the invention described herein broadly consists in system for use during a sporting activity, comprising: a power source; a camera arranged to capture an image in a user's field of vision; one or more processors having access to non-transitory storage and configured to execute software to detect presence of a basketball hoop in the image, to determine a three dimensional position of the hoop, calculate an ideal trajectory between the user and the hoop whereby a basketball following the trajectory will pass through the basketball hoop, and determine an apex of the trajectory; and a wearable near-eye display apparatus having a projector configured to display a graphic on the near-eye display at the trajectory apex, the visual graphic representing a target.

In an embodiment, a basketball hoop backboard having a known graphic pattern, wherein the software is configured to detect the presence of the hoop comprises by detecting the graphic pattern.

In an embodiment, the ideal trajectory is a trajectory whereby a basketball following the trajectory will pass through the basketball hoop without touching the backboard or the hoop. The trajectory may be one calculated mathematically to optimise an aspect of the trajectory such as to minimise the trajectory length. Alternatively the trajectory may be calculated on a preferred or characteristic trajectory of the user or of another player, for example a professional player the user desires to emulate.

In an embodiment, the visual graphic representing the target comprises a shape centred on the highest point of the trajectory.

The near-eye display may comprise an augmented reality headset or a virtual reality headset. A user interface may be provided on the headset or elsewhere for controlling operation of the system.

In a fourth aspect, the invention described herein broadly consists in non-transitory storage media comprising instructions for execution by a processor to provide an image on a wearable near-eye display, comprising: obtaining and analysing an image in a user's field of vision; detecting the presence of a basketball hoop in the image; determining the three dimensional position of the hoop relative to a user; calculating an ideal trajectory between the user and the hoop, whereby a basketball following the trajectory will pass through the basketball hoop; determining the apex of the trajectory; and displaying on the near-eye display, a visual graphic at the trajectory apex, the visual graphic representing a target.

In an embodiment, the instruction(s) for detecting the presence of a basketball hoop comprises detecting a known graphic on a backboard of the basketball hoop.

In an embodiment, the storage media comprises stored information about one or more known graphics for display on the backboard.

In an embodiment, calculating the ideal trajectory comprises calculating a trajectory whereby a basketball following the trajectory will pass through the basketball hoop without touching the backboard or the hoop. The trajectory may be one calculated mathematically to optimise an aspect of the trajectory such as to minimise the trajectory length. Alternatively the trajectory may be calculated on a preferred or characteristic trajectory of the user or of another player, for example a professional player the user desires to emulate.

This invention may also be said broadly to consist in the parts, elements and features referred to or indicated in the specification of the application, individually or collectively, and any or all combinations of any two or more said parts, elements or features. Where specific integers are mentioned herein which have known equivalents in the art to which this invention relates, such known equivalents are deemed to be incorporated herein as if individually described.

The term ‘comprising’ as used in this specification and claims means ‘consisting at least in part of’. When interpreting statements in this specification and claims that include the term ‘comprising’, other features besides those prefaced by this term can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range and any range of rational numbers within that range (for example, 1 to 6, 1.5 to 5.5 and 3.1 to 10). Therefore, all sub-ranges of all ranges expressly disclosed herein are hereby expressly disclosed.

As used herein the term ‘(s)’ following a noun means the plural and/or singular form of that noun.

As used herein the term ‘and/or’ means ‘and’ or ‘or’, or where the context allows, both.

### BRIEF DESCRIPTION OF THE DRAWINGS

The present invention will now be described by way of example only and with reference to the accompanying drawings in which:

FIG. 1 is a schematic showing a first embodiment system to provide an enhanced sports training experience;

FIG. 2 is a schematic showing the overlay of a virtual target overlaid onto a basketball hoop according to embodiments of the present invention;

FIG. 3 shows a frame captured by the camera, of a major portion of a user's field of view through an augmented reality headset, and showing a virtual target projected on to the field of view;

FIG. 4 is an elevation view of a basketball backboard and hoop according to an embodiment;

FIG. 5 is an elevation view of a basketball hoop with a backboard having a graphic pattern according to an embodiment;

FIG. 6 illustrates the components of the system and of FIG. 1;

FIG. 7 illustrates the components of the headset of the system according to an embodiment;

FIG. 8 illustrates the components of the processor of the headset according to an embodiment;

FIG. 9 is a flowchart illustrating an embodiment method of providing an enhanced sports training experience; and

FIG. 10 illustrates an example embodiments of a coordinates based position system and ideal trajectory factors according to an embodiment.

### DETAILED DESCRIPTION OF A PREFERRED EMBODIMENT

In the following description, specific details are given to provide a thorough understanding of the embodiments. However, it will be understood by one of ordinary skill in the art that the embodiments may be practiced without these specific details. For example, modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of hardware system, hardware platform, programmable device, general purpose computer system or computing device, including, but not limited to, a desktop, laptop, notebook, tablet, smart television, or mobile device. The term “mobile device” includes, but is not limited to, a wireless device, a mobile phone, a smart phone, a mobile communication device, a user communication device, personal digital assistant, mobile hand-held computer, a laptop computer, wearable electronic devices such as smart watches and head-mounted devices, an electronic book reader and reading devices capable of reading electronic contents and/or other types of mobile devices typically carried by individuals and/or having some form of communication capabilities (e.g., wireless, infrared, shortrange radio, cellular etc.). As will be appreciated, these systems, platforms and devices generally comprise one or more processors and memory for executing programmable instructions.

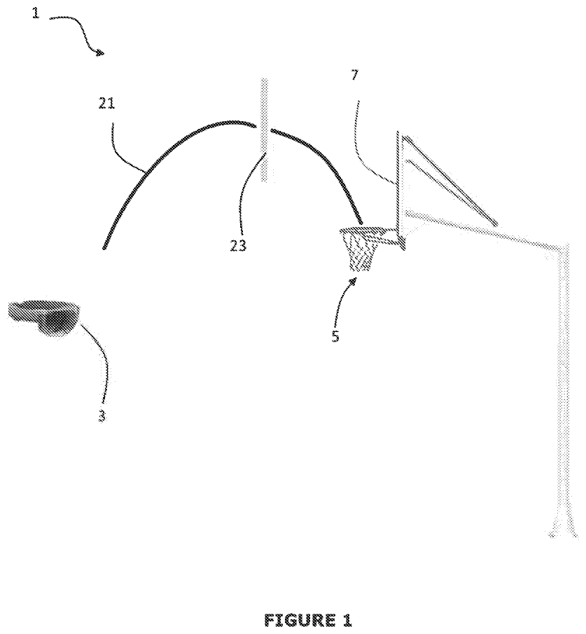

FIGS. 1 to 10, illustrate a system 1, apparatus 3, and method 301 to provide an enhanced sports training experience. In particular the system 1, apparatus or headset 3, and method 301 provide a training aid to assist a player with shooting a basketball 25 into a basketball hoop 5.

### Enhanced Sports Training System and Apparatus

a. Headset

The system 1 comprises an apparatus or headset 3 such as an augmented reality headset or device or a virtual reality headset or device. As used herein, the term “augmented reality” encompasses methods and devices that may also be known as “mixed reality” methods and devices. An augmented reality device is preferred over a virtual reality device, as generally an augmented reality device does not substantially obscure or limit the field of vision of the wearer, who substantially maintains their peripheral vision while wearing the headset or device, giving a more realistic visual experience.

The apparatus or headset 3 comprises a wearable near-eye display 9 through which a user is able to view their surroundings and is configured to display one or more virtual objects including a shot apex 23 and/or shot trajectory to the user overlaid on their surroundings. The apparatus or headset 3 further comprises at least one camera or image capture device 11, which is configured to obtain images of the user's surroundings. Images obtained are processed by a processor 13 which utilises instructions stored on a non-transitory storage medium 15 to at least detect the presence of a basketball backboard 7 or hoop 5 in the obtained image(s), and to determine the relative position of the apparatus or headset 3 to a detected basketball backboard 7 or hoop 5 and then determine one or more shot trajectories, each including a shot apex, based on the relative position of the apparatus or headset 3 to the detected basketball backboard 7 or hoop 5. The apparatus or headset 3 further comprises a power source(s) 17 configured to provide electrical power to the processor 13, the camera(s) 11 and the display 9.

i. Image Display

The apparatus or headset 3 comprises a wearable near-eye display 9 through which a user is able to view their surroundings and is configured to display one or more virtual objects including a shot apex 23 and/or shot trajectory to the user overlaid on their surroundings.

In embodiments where an augmented reality device is used, the wearable near-eye display 9 comprises an optically transparent display or lens which is configured to display virtual objects overlaid with the real objects in a user's surroundings in real time. A user wearing an optically transparent display device will see with their natural sight their surroundings through the transparent display or lens, which are not occluded by the display. Any virtual objects or virtual effects shown on the optically transparent display will be shown to be overlaid or transposed over or within the real-world surroundings in the user's field of view.

In embodiments where a virtual reality device is used, the wearable near-eye display comprises a monitor-based display such as an LED screen or LCD screen which displays an entirely virtual environment to a user. However, it will be appreciated that in such embodiments, a user's surroundings or field of view may be displayed back to them through the wearable near-eye display so in effect they view their surroundings, albeit a recording or real time transmission, with overlaid virtual objects or effects. As such, a user sees displayed image data of real objects in their surroundings, substantially as they would appear with the natural sight of the user, as well as overlaid or transposed image data of virtual objects or virtual effects.

The wearable near-eye display is electrically connected to an image generation unit which produces visible light representing virtual objects or virtual effects and provides said visible light representing virtual objects or effects to the wearable near-eye display. As such, the image generation unit is configured to display virtual objects and/or effects to appear overlaid or transposed over the surroundings of a user as seen in their field of view though the wearable near-eye display.

In some embodiments, the virtual objects or effects are displayed on the wearable near-eye display by the image generation unit at a designated depth location in the user's display field of view to provide a realistic, in-focus three dimensional display of a virtual object or effect overlaid or transposed over the surroundings in the field of view. In further embodiments, these three-dimensional display of a virtual object or effect can interact with one or more real objects. For example, if a basketball is detected in the field of vision passing through or otherwise interacting with the virtual object or effect overlaid on the display, then the object or effect may indicate this interaction, for example by flashing or changing colour.

In some embodiments, the image generation unit projects images of one or more virtual objects or effects using coupling optics such as a lens system for directing images from the image generation unit to a reflecting surface or element which is provided near the eye of a user. The reflecting surface or element directs the light from the image generation unit representing the image into the user's eye. The reflecting surface or element may also be substantially transparent so that light from a user's environment or surroundings is received by the user's eye, allowing the user to have a direct view of their surroundings, in addition to receiving a virtual object or virtual effect from image generation unit.

ii. Image Capture

The apparatus or headset further comprises one or more cameras 11 or image capture devices, arranged to capture image(s) substantially relating to a user's field of vision. The camera(s) or image capture device(s) will be provided as part of the apparatus or headset 3, either integral with the headset or mounted to the headset, but alternatively the camera may be provided separate to the headset. The camera 11 is arranged to be located close to the eyes of a wearer of the headset, and to be directed away from the wearer of the headset such that the image captured by the camera closely resembles at least a major part of the field of vision of the wearer through the transparent display or lens(es) if the headset 3. Where a virtual reality headset is used, the image captured by the camera 11 preferably closely resembles at least a major part of what would form the field of vision of the wearer if the virtual reality headset were not obscuring the wearer's view of the surrounding environment.

The camera(s) or image capturing devices 11 are configured to capture image data such as video and/or still images, typically in colour, and substantially related to the field of vision of a wearer of the headset. The image data provided by the camera(s) or image capturing device(s) of the real world is used to locate and map real objects in the display field of view of the transparent display of the headset, and hence, in the field of view of the wearer.

In one embodiment the camera(s) or image capturing device(s) 11 is configured to continuously capture images substantially relating to the user's field of vision, and successive image frames from the camera are analysed. In alternative embodiments, image frames from the camera are analysed at a different frequency, such as every 2 frames, every 3 frames, or between ever 4 and ever 100 frames, depending on the requirements of the headset and/or system.

iii. Processor

The apparatus or headset 3 further comprises one or more processors 13, and non-transitory storage media 15. The non-transitory storage media stores software containing instructions to execute steps of the method described herein. The non-transitory storage media may be wirelessly or otherwise accessible to update or modify the instructions contained therein.

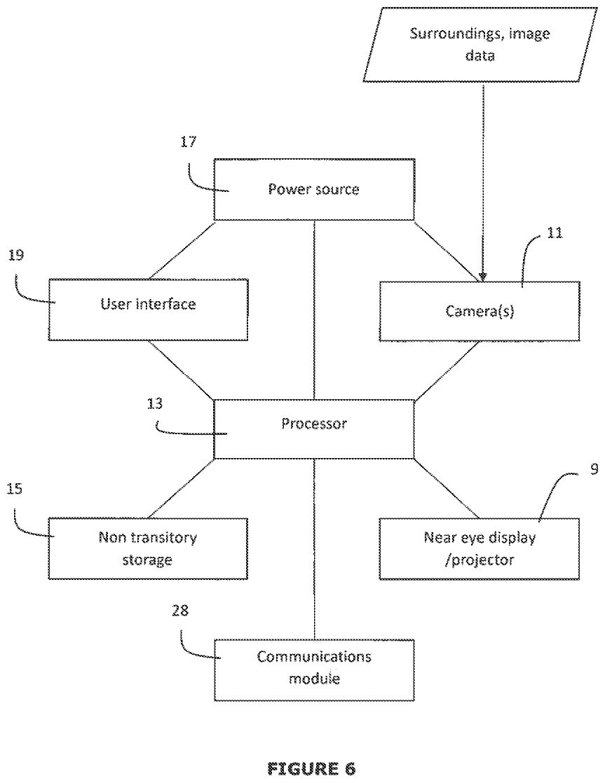

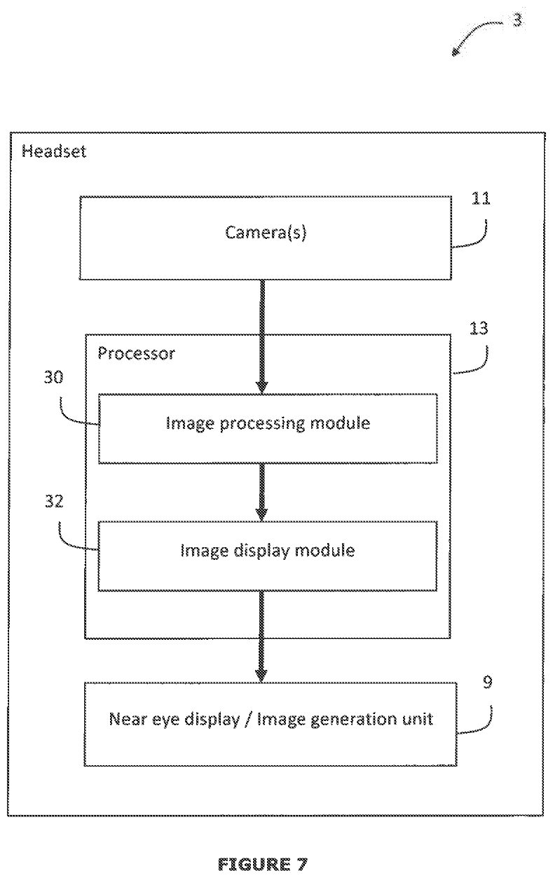

With reference to FIGS. 6 and 7, the processor 13 is configured receive and process image data from the camera(s) or image capturing device(s) 11 and to access the non-transitory storage media 15 to execute the instructions contained therein. The processor is further configured to provide input to the image generation unit relating to images or other visual components which are to be displayed on the near-eye display 9 to the user. The images or other visual components which are to be displayed may be based on the received and/or processed image data. The processor(s) 13 may include an image processing processor which is configured to run an image processing module or modules 30. The processor(s) 13 may include an image display processor which is configured to run an image display module 32. The processor(s) 13 may be provided as part of the apparatus/headset 3, or in alternative embodiments, may be separate to the headset and in wired or wireless communication with the apparatus/headset 3.

The processor(s) 13 may be connected to a communications module 28, which is configured to allow the processor(s) to communicate wired or wirelessly over one or more communication networks to one or more computer systems whether located nearby or at a remote location. For example the communications module 28 may communicate using any one or more of the following: Wi-Fi, Bluetooth, infrared, an infrared personal area network, RFID transmission, wireless Universal Serial Bus (WUSB), cellular, 3G, 4G, 5G or other wireless communication means.

The processor(s) 13 of the apparatus or headset 3 may leverage a computer system(s) accessed over the communications network(s) for processing power and/or remote data access. A module executing on one or more processors of the apparatus or headset 3 may be executed, or be partly executed, on the computer system(s). In such embodiments, data such as image data may be received by the processor and transmitted to the computer system via the communications module.

For example, the image processing module may execute solely on the processor of the apparatus or headset 3. In some embodiments, the processor 13 of the apparatus or headset 3 may function to receive image data, which is optionally pre-processed by the processor(s) 13, and then provided as input to the one or more computers systems 12 which runs the image processing module 30. Additionally, in some embodiments, the image processing module executing on different apparatuses or headsets 3 in the same environment may share data updates in real time, for example real object identifications in a peer-to-peer configuration between apparatus, or may be provided with shared data by the computer system(s) via the communications network(s). Additionally, in some embodiments, image data received by computer system is used as training data or otherwise input data to one or more computer vision, or machine learning algorithms executed by the image processing module.

b. Other Components of the Headset

The apparatus or headset 3 also comprises one or more power sources 17 such as a rechargeable battery or AC power source, configured to provide power to the processor 13, the camera 11, and the near-eye display 9. A user interface may be also provided to enable to user to adjust operation of one or more of the power sources, 17, or to input instructions to the processor to adjust aspects of the headset, the system and/or the method. In some embodiments, an audio source such as an earphone of a set of earphones may also be provided in the headset in order to provide audio cues, or to allow a user to listen to audio while using the system.

In some embodiments, the apparatus or headset may also comprise an inertial measurement unit (IMU) including one or more inertial sensors such as a magnetometer, a three-axis gyro, and one or more accelerometers. The inertial sensors are for sensing movement, position, orientation, and sudden accelerations of the apparatus or headset 3. From the information received or provided by the IMU, the processor is able to determine movements of the user, the head position of the user, and the orientation of the headset, all of which can be used to indicate changes in the user perspective and the display field of view for which virtual data is shown to the user. This IMU data in some embodiments is used in the image processing module to determine the location of the backboard and/or the ideal trajectory. For example, the IMU data may indicate the user has moved in a certain direction, from which the image processing module is able to determine the relative position of the user to the backboard in real-time more accurately.

In some further embodiments, one or more external image capture devices may be provided, which are configured to be connected via the communications network(s) to the apparatus or headset 3 and/or the computer system(s). The image capture device(s) may be, for example one or more cameras such as 3D cameras that visually monitor the environment, which may comprise one or more users, the objects of concern to the tracking, such as one or more basketballs, and the surrounding space such that gestures and movements performed by the one or more users, as well as the structure of the surrounding space including surfaces and objects. The image data, and depth data if captured by the one or more 3D capture devices may supplement image data received and processed by the apparatus or headset 3. The image data may be provided over the communications network(s) to the processor(s) 13 and/or the computer system, which may then be may be processed, analysed, and tracked in order to supplement the image processing of the users environment performed by the image processing module.

### Enhanced Sports Training Method

The invention relates to an electronic or digital system including a processor configured to provide an enhanced sports training experience to a user. In some embodiments, the system and/or processor comprises different modules which operate together to provide an automated sports training experience. It will be appreciated that in other embodiments the system may be partially automated for some aspects or may be entirely manually operated, depending on the configuration.

Referring to FIG. 7, the processor(s) 13 has an image processing module 30 which runs on the processor and is configured to receive and process images and/or image data from the camera(s) 11. The processor(s) 13 is also configured to run an image display module 32, which uses the results of the processed image data, such as the calculated ideal trajectory and/or apex to a detected basketball hoop, to display relevant information to the user or wearer of the headset 3. In this embodiment the processor(s) 13 containing the image processing module 30 and the image display module 32 are provided as part of the apparatus/headset 3. In alternative embodiments, the image processing module 30 and/or the image display module 32 may be performed on a computer system or systems remote to the headset, via a wired or wireless communication network with the apparatus/headset 3.

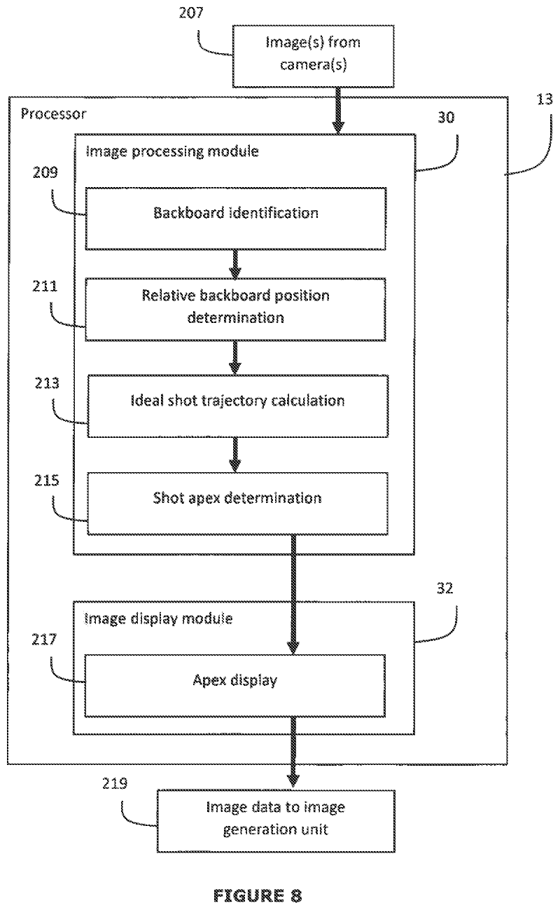

FIG. 8 shows these modules in more detail. The image processing module 30 has a number of sub-modules, including a backboard identification sub-module 209 which receives image(s) and/or image data 207 from the one or more cameras or image capture devices and determines if a backboard 7 is present in the image(s), a relative backboard position determination sub-module 211 which determines the relative position of a detected backboard 7 to the user or wearer of the headset, an ideal shot trajectory calculation sub-module 213, which, based on the relative position of the backboard 7 to the user at 211, determines the ideal trajectory of a basketball shot to travel through the hoop 5, and a shot apex determination sub-module 215, which, determines the apex of the ideal trajectory calculated by 213.

The image display module 32 takes the ideal shot apex determined at 215, and in some embodiments the ideal shot trajectory calculated at 213, and runs an apex display sub-module 217 which creates display image data which is then passed to the image generation unit of the near-eye display 9. The image generation unit then proceeds to display the apex and/or the ideal trajectory determined at 215 and 213 respectively to the user through the near-eye display 9.

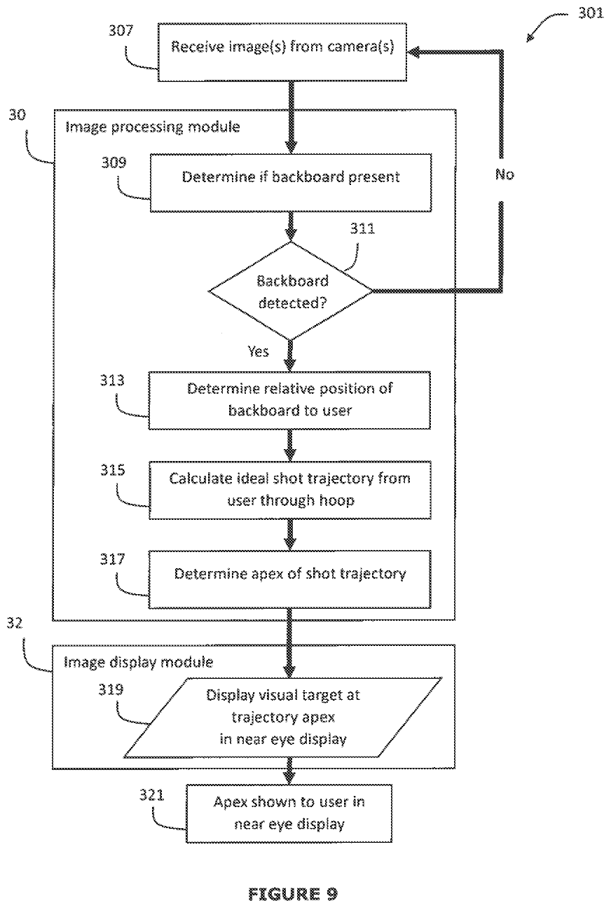

FIG. 9 shows the corresponding method 301 which is performed by the processor 13, comprising the image processing module 30 and the image display module 32. The processor 13 at first step 307 receives image(s) and/or image data from the camera(s) or image capture devices 11. The images(s) are then provided to the image processing module 30 of the processor 13. At step 309 the image data is processed to determine if a backboard 7 is present in the image(s). If no backboard is detected, at step 311, the processor will repeat, and steps 307 and 309 will be performed until a backboard 7 is detected.

Once detected, the image processing module moves to step 313 where the relative position of the user or wearer of the headset to the backboard is determined based on the detected backboard in the image(s) received from the camera(s) at step 307. Once the relative position of the user or wearer of the headset is known, the processor then proceeds to calculate the ideal shot trajectory from the user's position through the hoop 5 of the basketball hoop. This ideal shot trajectory is based off a pre-configured approach angle into the hoop 5 for a ball. This pre-configured approach angle for the ideal shot trajectory may be pre-set by the user of the device, or may be based on an ideal approach angle for the highest chances of success in a basketball shot. At step 317 the apex or peak of the ideal shot trajectory calculated at step 315 is determined, based on the trajectory.

The image display module 32 at step 319 then receives the ideal shot apex determined at step 317, and in some embodiments the ideal shot trajectory calculated at 315, and creates display image data which is then passed to the image generation unit of the near-eye display 9. The apex is then shown to the user or wearer of the headset through the near-eye display at step 321.

Each of these steps and its corresponding sub-module as shown in FIGS. 8 and 9 will now be explained in more detail below.

a. Image Processing Module

Referring to FIG. 9, in a first step 307 of method 301, an image 27 or image data relating substantially to the wearer's field of vision is captured by the one or more cameras 11 or image capture devices and is then provided to the processor 13. In alternative embodiments, image(s) or image data relating substantially to the wearer's field of vision as captured by the one or more cameras 11 or image capture devices of the headset 3 and provided directly to one or more computers systems 12 external to the headset over a communications network. In these embodiments the one or more computer systems are configured to run the image processing module.

In alternative embodiments, the processor 13 of the apparatus or headset 3 may function to receive image data, which is optionally pre-processed by the processor(s) 13, and then provided as input to the one or more computers systems 12 which runs the image processing module.

i. Backboard Identification Sub-Module

The processor 13, specifically the backboard identification sub-module 209 of the image processing module 30, at step 309, analyses the image 27 or image data received from the one or more cameras 11 or image capture devices to detect the presence (or absence) of a basketball backboard 7 in the image(s).

During step 309, the processor 13 analyses each image frame received to determine whether the backboard 7 is present in each frame. This is done by a detection algorithm, which is performed by the backboard identification sub-module 209. The detection algorithm takes as input each image frame received, and analyses the image frame in order to detect if a backboard is present or not.

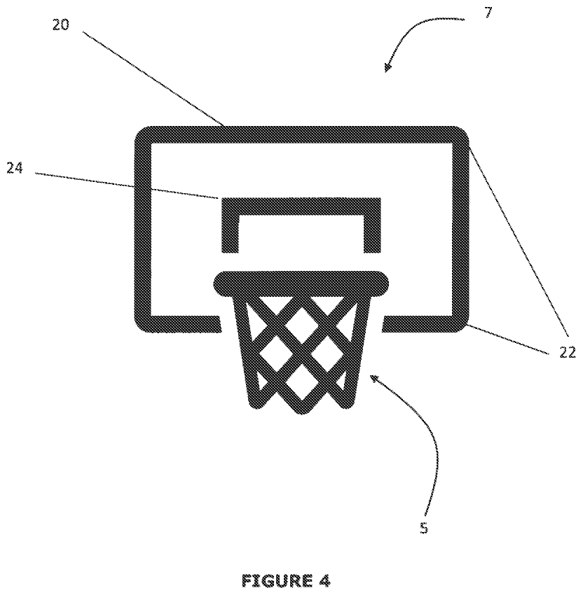

With reference to FIG. 4, in one embodiment, the detection algorithm uses one or more edge detection algorithms to process the image frame, such as canny edge detection, and to detect the edges 20 of the backboard 7. The edges of a typical basketball backboard such as that shown in FIG. 4 are able to be detected in an image frame by the edge detection algorithm run by the processor.

In some embodiments, the detection algorithm uses one or more corner detection algorithms to detect one or more corners 22 of the backboard 7 in the image frame. The corners of a typical basketball backboard such as that shown in FIG. 4 are able to be detected in an image frame by the corner detection algorithm run by the processor. The corner detection algorithm is able to identify one or more points for which there are two dominant and different edge directions. The corner detection algorithm can be used alongside the edge detection algorithm as a corner is the intersection of two edges. As such, in some embodiments, the detection algorithm uses a combination of edge detection and corner detection to detect the edges of a backboard, as well as the corners of the backboard.

The backboard detection sub-module 209 may have inbuilt or preconfigured parameters stored by the system, which relate to one or more ranges for the dimensions and/or arrangements of the edges around a basketball backboard. These parameters could define typical edge and/or corner dimensions and/or arrangements or relative positions for a number of different styles or types of basketball backboards. The inbuilt or preconfigured parameters are able to be modified and updated by a user, or through an external computer system to the headset via a communication network, such as through a software update.

In an embodiment, the backboard identification sub-module 209 of the image processing module 30 employs one or more machine learning algorithms to perform the feature detection of a backboard and/or determine if a backboard is present in an image frame. The one or more machine learning algorithms may be performed by a model such as an artificial neural network or decision tree.

In such embodiments, the backboard identification sub-module 209 may employ a supervised machine learning algorithm to detect if a backboard is present in an image frame. The machine learning algorithm can be trained based on a set of data that contains both inputs and corresponding desired outputs. The data is known as training data, and may comprise as inputs a range of images and/or image data containing different basketball backboards in a range of different positions, and from a range of different perspectives or vantagepoints. Each input can have an associated desired output, such as a binary ‘backboard is present’ if there is a backboard in the image, or ‘backboard is not present’ if not. The input images and associated presence outputs consists of a set of training examples based on which the machine learning algorithm is able to create a model to detect the presence of a backboard in newly inputted images received from the camera 11 of the system, which do not have associated outputs.

To train the machine learning model, a large, representative sample of training data is required to produce accurate detection of a backboard. Training data may be taken from real world images such as photographs or video frames which contain different backboards, or may be created in a virtual environment. Training images from a virtual environment may be created in a three dimensional simulated virtual environment, which is able to simulate a large subset of training data comprising different types or styles of backboards, different backgrounds behind the backboards representing the surrounding environment, and different three dimensional locations or positions the backboards are viewed from. Producing training images in such a virtual environment therefore allows a large subset of different images to be simulated and used to train the machine learning algorithm. In some embodiments the training data may comprise both real world and simulated images with accompanying outputs.

The machine learning algorithm is ‘trained’ using the set of training data containing a range of different backboards in a range of different environments, and from a range of different perspectives. The machine learning algorithm is then used to detect the presence of a backboard in newly inputted images received from the camera 11 of the system, which do not have associated outputs. The machine learning algorithm provides an output such as ‘backboard is present’ if it detects a backboard in the image, or ‘backboard is not present’ if not. Step 311 then takes this output and moves to step 313 if a backboard is detected, or loops back to step 307 and the system analyses the next frame received from the camera if a backboard is not detected.

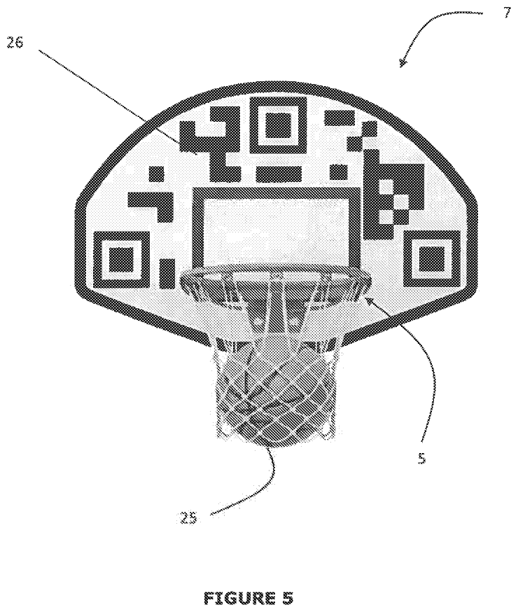

In some embodiments, to assist with detecting the hoop 5 and determining its three dimensional position relative the user or wearer of the headset 3, the basketball hoop 5 may be provided with a backboard 7 that contains a graphic pattern. The graphic pattern may be one that is known to the system 1, and is stored in the non-transitory storage media 15, or one that is easily recognisable to the system 1. The pattern may be a geometric pattern containing a number of lines and/or shapes. In some embodiments the geometric pattern may resemble that of a QR code, as shown in FIG. 5. The pattern may be black and white or coloured, and is preferably a high contrast pattern and/or preferably comprises a distinctive pattern. In some embodiments the graphic pattern may be one that is unique to the user and, for example, may be designed by the user and stored in the non-transitory storage 15.

In some embodiments, a graphic pattern or other graphic markings may enable the feature detection such as edge or corner detection, or one or more machine learning algorithms detect a backboard more easily. A graphic pattern or markings may be more easily identified by the backboard detection sub-module, especially in crowded or busy surrounding environments. A specific graphic marking such as an image may also be more easy for a feature extraction algorithm to detect. In embodiments where a graphic image or marking is used with a machine learning algorithm, the graphic image or marking, for example a cross or x, may be located on the training images, to enable the machine learning algorithm to determine the presence of the cross or x on the backboard.

In some embodiments, in order to identify a backboard in an image frame, the backboard identification sub-module 209 may employ any combination of one or more trained machine learning algorithms, feature detection such as edge detection and/or corner detection, and/or the use of a graphic pattern printed on the backboard.

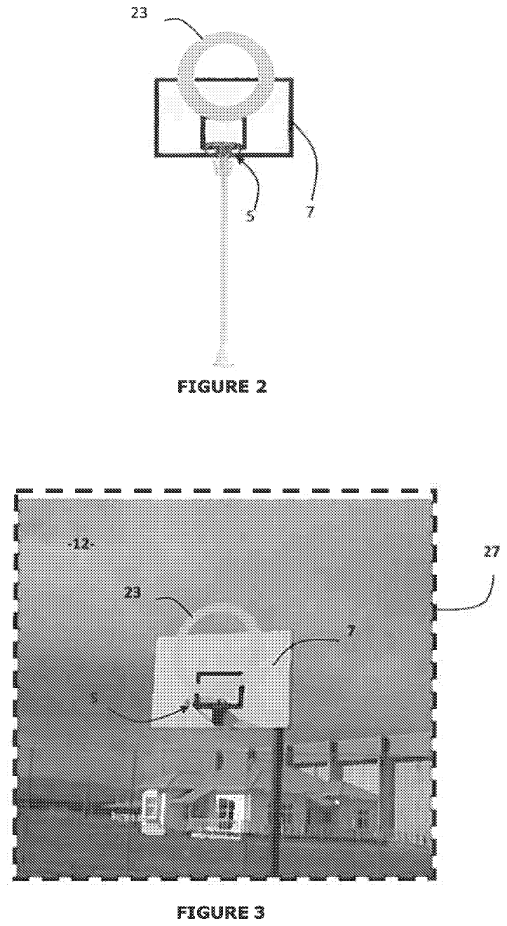

During the step of identifying the basketball backboard 7, the processor 13 receives image data from the camera 11 and analyses each image frame to determine whether the backboard 7 is present in each frame using feature detection, by searching for a known geometric pattern. When the backboard 7 is detected by detecting a geometric pattern, the processor 13 thereby identifies the hoop 5. A graphic pattern may enable the processor to more readily recognise the backboard 7 irrespective of the visual characteristics of the surrounding environment. This may be particularly advantageous where the environment surrounding the hoop 5 is busy. However, in alternative embodiments, the backboard 7 may instead be a standard basketball backboard without a graphic pattern, as illustrated in FIGS. 2 and 3.

If no backboard is detected, at step 311, the processor will repeat, and steps 307 and 309 will be performed until a backboard 7 is detected. Where a backboard 7 is detected, the processor then proceeds to step 313, where the three-dimensional position of the backboard 7 relative the position of the wearer of the headset 3 is then determined.

ii. Relative Backboard Position Determination Sub-Module

The relative backboard position determination sub-module 211 of the image processing module 30, at step 313, analyses the image 27 or image data received from the one or more cameras 11 or image capture devices to determine the relative position of the basketball backboard 7 to the headset or device 3, as seen through the camera 11 which substantially represents the user or wearer's field of view.

At step 313, the relative backboard position determination sub-module 211 of the processor 13 analyses each image frame received to determine the relative position of the backboard 7 to the headset or device 3. In an embodiment, this is done by a backboard mapping algorithm, similar to that performed by the backboard identification sub-module 209 at step 309. The backboard mapping algorithm takes as input each image frame received, which has a detected backboard in it, and analyses the backboard in order to determine the relative orientation and size of the backboard in the image frame, in order to determine the approximate distance the backboard is from the user, and the angle the backboard 7 is at with respect to the camera 11.

With reference to FIG. 4, in one embodiment, in order to determine the relative orientation and size of the backboard in the image frame, the backboard mapping algorithm uses one or more edge detection algorithms to process the image frame, such as canny edge detection, and to determine the relative dimensions of the edges 20 of the backboard 7 as seen by the user. The edges of a typical basketball backboard such as that shown in FIG. 4 are able to be detected and measured in an image frame by the edge detection algorithm run by the processor.

In some embodiments, the backboard mapping algorithm also uses one or more corner detection algorithms to detect one or more corners 22 of the backboard 7 in the image frame. The corners of a typical basketball backboard such as that shown in FIG. 4 are able to be detected in an image frame by the corner detection algorithm run by the processor. The corner detection algorithm is able to identify one or more points for which there are two dominant and different edge directions. The corner detection algorithm can be used alongside the edge detection algorithm as a corner is the intersection of two edges, to help determine the relative dimensions of the edges 20 of the backboard 7 as seen by the user, and thus to determine the relative orientation and size of the backboard in the image frame.

The relative backboard position determination sub-module 211 may have inbuilt or preconfigured parameters stored by the system, which relate to one or more ranges for the dimensions and/or arrangements of the edges around a basketball backboard. These parameters could define typical edge dimensions and/or arrangements or relative positions for a number of different styles or types of basketball backboards. The inbuilt or preconfigured parameters are able to be modified and updated by a user, or through an external computer system to the headset via a communication network, such as through a software update.

In one embodiment, the relative backboard position determination sub-module 211 of the image processing module 30 employs one or more machine learning algorithms to determine the relative orientation and size of the backboard in the image frame to the user or the headset, and to determine the relative position of the backboard to the user or the headset. The one or more machine learning algorithms may be performed by a model such as an artificial neural network or decision tree.

In such embodiments, the relative backboard position determination sub-module 211 may employ a supervised machine learning algorithm to determine the relative orientation, size and/or position of the backboard in the image frame to the user or the headset. The machine learning algorithm can be trained based on a set of data that contains both inputs and corresponding desired outputs. The data is known as training data, and may comprise as inputs a range of images and/or image data containing different basketball backboards in a range of different positions, and from a range of different perspectives or vantagepoints. Each input or image can have an associated desired output or outputs, which defines the relative orientation and/or size and/or position of the backboard in the image to the camera used to capture the image. The input images and associated presence outputs consists of a set of training examples based on which the machine learning algorithm is able to create a model to determine the relative position of the backboard to the camera or capture point in newly inputted images received from the camera 11 of the system, which do not have associated outputs.

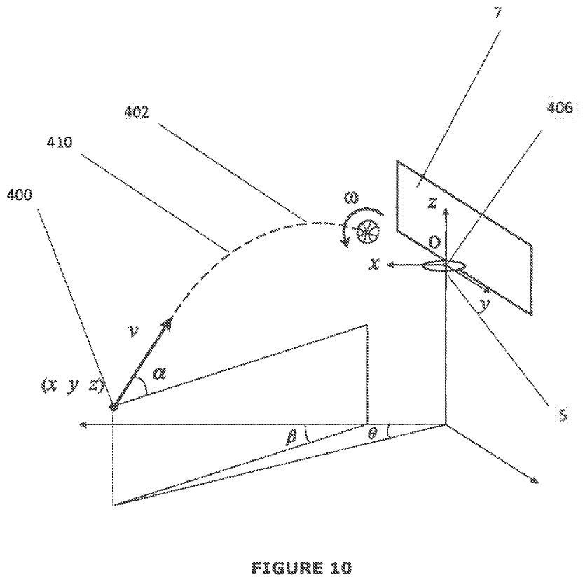

To train the machine learning model, a large, representative sample of training data is required to produce accurate real-world determination of relative position of the headset to a backboard. Input training data may be taken from real world images such as photographs or video frames which contain different backboards, or may be created in a virtual environment. The input training data has an associated output or output data which comprises at least the relative position of the backboard to the location from which the image was taken. In other embodiments the output or output data comprises a position of the user at the point of capture of the image, and a position of the backboard. In either embodiment, this output or output data relating to the positions of the user and the backboard is represented in a three-dimensional coordinate system. For example, with reference to FIG. 10, the position of the point of capture 400 and the position of the backboard 406 are defined in a three dimensional coordinate system having orthogonal X, Y and Z axes in which a Z-axis represents a depth position from a reference point. As such, the relative position of the backboard to the user at the point of capture can be represented in the same three-dimensional coordinate system.

Training images from a virtual environment may be created in a three dimensional simulated virtual environment, which is able to simulate a large subset of training data comprising different types or styles of backboards, different backgrounds behind the backboards representing the surrounding environment, and different three dimensional locations or positions the backboards are viewed from. A virtual environment therefore allows a large number of training images to be compiled quickly, as the image representing the field of vision and its corresponding relative position of the backboard are readily available. Producing training images in such a virtual environment therefore allows a large subset of different images and corresponding outputs relating to the relative positions of the backboard to the point of capture to be simulated and used to train the machine learning algorithm. In some embodiments the training data may comprise both real world and simulated images of backboards with accompanying outputs relating to the relative positions of the backboards.

The machine learning algorithm is ‘trained’ using the set of training data containing a range of different backboards in a range of different environments, and from a range of different perspectives. The machine learning algorithm of the relative backboard position determination module 211 is then used to determine the relative location of the backboard in newly inputted images received from the camera 11 of the system, which do not have associated outputs. Based on the real-world input image(s), the machine learning algorithm is able to provide output(s) defining the relative position of the backboard to the user at the point of capture of the image(s). This may be represented in a three-dimensional coordinate system, or may be as a relative distance and angle from a set point. Step 315 then takes this relative positional output data to calculate the ideal shot trajectory based on the relative position of the user to the hoop.

The relative position of the backboard to the user at the point of capture can be represented in the same three-dimensional coordinate system. The relative backboard position determination module 211 at step 313 uses the three-dimensional positions of the user at the point of capture and the backboard to determine the distance and angle of the backboard relative to the user. Based on the three-dimensional position of the backboard 7 relative to the camera 11 and/or to another point such as the headset/near-eye display, the relative position of the hoop 5 is also able to be determined.

In some embodiments, during the step 313 of determining the three-dimensional position of the hoop 5 relative to the user, two or more predetermined, known marker points are identified on the backboard 7. For a standard backboard, these points may include features such as, for example, an edge or corner of the backboard, or an edge or corner of a standard marking on the backboard. For a backboard having a graphic pattern, these marker points may be delineated by features such as, for example, an edge or corner of the backboard or a specific shape on the backboard, or an edge or corner of a specific geometric feature of the geometric pattern.

In these embodiments, the relative positions of the two or more know points is then analysed and the information about their relative positions, along with their position in the image frame, is used to determine the three dimensional position of the hoop 7. The distance between the marker points provides information from which the depth of the hoop 5 in the frame 27 can be determined; the relative positions of the points provides information about the angle/orientation of the backboard, and the absolute position of the points in the frame provides information about the position and height of the backboard relative to the near-eye display.

Based on the positions of the marker points on the backboard, the three dimensional position of the hoop 5 relative to the camera 11 and/or to another point such as the headset/near-eye display is also able to be calculated.

Once the position of the backboard relative to the headset has been determined, the relative backboard position determination sub-module 211 provides as output to the ideal shot trajectory calculation module 213 the relative position of the backboard 7 and/or hoop 5 in a three-dimensional coordinate based system.

iii. Ideal Trajectory Determination Sub-Module

Once the relative position of the backboard to the user or wearer of the headset is known, the processor then proceeds in a next step 315, to calculate an ideal shot trajectory from the position of the user, or another specified point forward of the near eye display, through the basketball hoop 5. This calculation is performed by the ideal shot trajectory calculation sub-module 213, which uses the relative position of the backboard 7 to the user from previous step 313 as input, and determines the ideal trajectory of a basketball shot to travel through the hoop 5 based on the relative position of the user to the backboard and the hoop.

The ideal trajectory 21 is calculated and is one whereby a basketball following the trajectory will pass through the basketball hoop 5, preferably without touching the backboard or the hoop i.e. the shot will be made. The trajectory preferably ends at a centre point of the hoop therefore, if a ball slightly veers from the trajectory in any direction, there is still an allowance for the ball to travel through the hoop, it may just hit the rim of the hoop on its way through.

The trajectory may be calculated according to a user-selected rule, for example, a known trajectory for the user's preferred shooting style, a trajectory that is characteristic of another player's shooting style, for example a professional player, or a trajectory that meets certain mathematical rules such as providing the shortest travel path or highest arc for a shot to pass through the hoop without contacting the hoop.

FIG. 10 shows an example of a parabolic path 410 defining the ideal shot trajectory. The parabolic path 410 is defined between the location of the user or the headset, which is represented in a three-dimensional coordinate system at point 400. This is the starting point for the parabola, and the approximate location that the ball is launched from by the user. The relative position of the hoop 5 to the user is represented in a three-dimensional coordinate system at point 406. The highest point, or apex of the parabola is shown at point 402.

In embodiments, the ideal shot trajectory is based off pre-configured user settings. These settings may be the ideal approach angle for the shot into the hoop, the ideal launch angle of the users shot, the launch velocity of the users shot, or a combination of these factors.

The shot trajectory may be based on a pre-configured approach angle into the hoop 5 for a ball. This pre-configured approach angle for the ideal shot trajectory may be pre-set by the user of the device, or may be based on an ideal approach angle for the highest chances of success in a basketball shot. For example, a medium high arc providing an approach angle to the hoop of between 40 and 50 degrees, or more preferably between 43 and 47 degrees, may give the user a higher chance of the shot resulting in an optimal shot.

In an embodiment, the ideal shot trajectory may also be based on a pre-configured or pre-set launch angle of the users shot a, or a preconfigured launch velocity v of the users shot. The launch angle α and/or the launch velocity v pre-set or pre-configured by the user may be used to calculate the parabolic path of the ideal trajectory between the user and the relative position of the hoop. If these are not pre-set by a user, a default launch angle and launch velocity will be used in the calculation of the parabolic path.

As shown in FIG. 10, the ideal shot trajectory calculation sub-module 213, uses the relative position of the hoop 5 to the user 406 from previous step 313 as input, and determines the ideal trajectory 410 of a basketball shot to travel through the hoop 5 based on the relative position of the user 400 to the backboard and the hoop. The parabolic path is calculated in three-dimensional space between the coordinate location of the user 400 and the coordinate location of the hoop 406. This parabolic path is calculated using, and expressed in a coordinates system based on the relative position of the hoop and backboard to the headset or device, and as such the user.

iv. Apex Determination Sub-Module

A subset of the ideal shot trajectory calculation performed at step 315 is the apex determination at step 317, performed by the shot apex determination sub-module 215. Alternatively, this step is performed by the ideal shot trajectory calculation sub-module 213, as a sub-routine of the ideal shot trajectory calculation.

Based on the calculated trajectory 21, at step 315, the apex of the trajectory is determined, that is, the highest point in the arc of the trajectory 21. The apex of the trajectory is the vertex of the parabola representing the ideal shot trajectory as calculated in previous step 315. The apex is represented in the coordinates based on three dimensional space between the user and the hoop and backboard.

The apex of the shot trajectory 21 is then visually indicated to the wearer via the near-eye display 9, by projecting a visual graphic 23 in the form of a target at the trajectory apex. Optionally, the trajectory 21 itself may be visually displayed to the wearer via the near-eye display, along with the visual graphic 23.

b. Image Display Module

At step 319, the image display module 32 takes the ideal shot apex determined by the shot apex determination module 215, and in some embodiments the ideal shot trajectory calculated at 213, and runs an apex display sub-module 217 which creates one or more sets of display image data which is provided to the image generation unit of the near-eye display 9. The image generation unit is configured to, using the set of image data provided, display the apex and/or the ideal trajectory determined at steps 317 and 315 respectively to the user through the near-eye display 9.

The image generation unit produces visible light representing the apex and/or the shot trajectory based on the display image data provided by the image display module 32 and provides said visible light representing the apex and/or the shot trajectory to the wearable near-eye display 9. As such, the image generation unit is configured to display the apex and/or the shot trajectory to appear overlaid or transposed over the surroundings of a user as seen in their field of view though the wearable near-eye display.

In some embodiments, the image generation unit projects images of the apex and/or the shot trajectory using coupling optics such as a lens system for directing images from the image generation unit to a reflecting surface or element which is provided near the eye of a user. The reflecting surface or element directs the light from the image generation unit representing the image of the apex and/or the shot trajectory into the user's eye. The reflecting surface or element may also be substantially transparent so that light from a user's environment or surroundings is received by the user's eye, allowing the user to have a direct view of their surroundings, in addition to viewing the apex and/or the shot trajectory from image generation unit.

In the case of an augmented reality device, the shot apex 23 and/or the shot trajectory 21 are displayed to the user by the image generation unit by projecting the image of the shot apex 23 for example on the lens of the device, such that it is overlaid on the user's field of vision via the headset. Where a virtual reality headset is used, the image 23 captured by the camera 11 is shown on the screen near the user's eyes, with the target 23 and/or the trajectory 21 overlaid onto that screen.

Generally, an augmented reality device is preferable at least in part because has a reduced risk of inducing motion sickness compared to a virtual reality device. In a virtual reality device, latencies between the capture and display of an image can cause motion sickness. However, a virtual reality device may provide a lower cost alternative, particularly where the device is one that operates by receiving a user's smart phone. In such an embodiment, a smart phone application may be provided to enable use of the smart phone, and optionally the camera 11 may be the smart phone camera.

The visual shot apex 23 displayed to the user or wearer represents a visual target intermediate the user and the hoop 5 for the user to aim the ball 25 towards to assist with shooting the basketball 25 into the hoop 5. The visual graphic representing the shot apex 23 may comprise a shape centred on the highest point of the trajectory. The shape may be solid or hollow. In the embodiment shown, the target is displayed as a hollow circle 23, i.e. a ring, preferably in a distinctive colour. However, in alternative embodiments the use of other shapes or visual indicators are envisaged.

The shot apex 23 is displayed with the appearance of being vertically oriented, i.e. oriented in a vertical plane. If a basketball 25 thrown by the user follows the calculated trajectory 23 it will appear to travel through the ring (or other shaped visual target) representing the shot apex 23. The shot apex 23 provides a helpful guide to the user to know how high to project their shot.

The visual target representing the shot apex 23 remains displayed as the user shoots the ball 25. Therefore, if the ball 25 misses the hoop 5 and also missed the target 23, the user will have been able to observe where the ball travelled in relation to the target 23 and ideal trajectory 21, and will be able to adjust any future shots accordingly, thus improving their shooting as a result.

c. Additional Features

In some embodiments, the method may further comprise the step of tracking the movement of the basketball 25 throughout the shot, and providing feedback to the user as to the trajectory that the basketball followed. Optionally, information may be visually indicated to the user to identify adjustments that may be required to the shot. In one embodiment, the target 23 changes its appearance if the ball is detected to have travelled through the target. In one embodiment the target 23 is displayed in red before the shot is taken, and configured to change to green when a ball is detected to have travelled through the target.

The target 23 and trajectory 21 are constantly recalculated, and the near-eye display is updated as the user moves around relative to the hoop 5 or backboard 7. Movement of the user may be detected by movement sensors provided by the IMU of the headset previously described, or otherwise worn by the user, for example an worn motion sensor external to the headset, or may alternatively be detected by visual changes between successive image frames recorded by the camera(s) or image capture device(s).

In one embodiment the camera(s) or image capture device(s) 11 is configured to continuously capture images substantially relating to the user's field of vision, and successive image frames from the camera are analysed. If differences are detected between the frames, for example movement of the reference points on the backboard, or movement or other points in the image, movement of the user is presumed and the method steps 307 to 321 as shown in FIG. 9 are repeated. That is, the system detects if a backboard is present, if a backboard is detected, it re-calculates of the trajectory and apex of an ideal shot, and updates the image of the target 23 shown on the near eye display. This preferably happens at a speed such that any changes to the display appear to a user to be instantaneous and to occur in tandem with their movement.

The non-transitory storage media 15 comprises instructions for execution by a processor to carry out the steps of the method described above. That is, obtain and analyse an image substantially related to a user's field of vision, detect the presence of a basketball backboard 7 in the image, determine the three dimensional position of the backboard relative to a user, and calculate an ideal trajectory between the user and the hoop whereby a basketball following the trajectory will pass through the basketball hoop.

In the presently described embodiment, the non-transitory storage media 15 further comprises instructions to determine the apex of the trajectory and displaying a visual graphic on the near-eye display at the trajectory apex, the visual graphic representing a target.

In some embodiments, the non-transitory storage media 15 comprises one or more machine learning algorithms which enable the detection of a basketball hoop, and/or the determination of the relative position of the backboard to the user. The non-transitory storage media 15 in further embodiments may comprise stored information about one or more known graphics for display on a basketball backboard 7 and instructions to detect said backboard graphics in the image or image data provided by the camera.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the foregoing, a storage medium may represent one or more devices for storing data, including read-only memory (ROM), random access memory (RAM), magnetic disk storage mediums, optical storage mediums, flash memory devices and/or other machine-readable mediums for storing information. The terms “machine readable medium” and “computer readable medium” include, but are not limited to portable or fixed storage devices, optical storage devices, and/or various other mediums capable of storing, containing or carrying instruction(s) and/or data.

The various illustrative logical blocks, modules, circuits, elements, and/or components described in connection with the examples disclosed herein may be implemented or performed with a general-purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the modules, components and/or functions described in connection with the examples disclosed herein or illustrated in the figures may be rearranged and/or combined into a single component or module, or embodied in several components or modules without departing from the invention. Additional modules, elements or components may also be added without departing from the invention. The modules elements or components may form sub-modules, sub-elements or sub-components within another module, element, or component. The sub-modules, sub-elements, or sub-components may be integrated with one or more other sub-modules, sub-elements, or sub-components. Other sub-modules, sub-elements, or sub-components may be divided into further sub-modules, sub-elements, or sub-components. Additionally, the features described herein may be implemented in software, hardware, as a business method, and/or combination thereof.

In its various aspects, the invention can be embodied in a computer-implemented process, a machine (such as an electronic device, or a general-purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

Preferred embodiments of the invention have been described by way of example only and modifications may be made thereto without departing from the scope of the invention. For example, while the invention has be described herein as applied to a training aid for basketball, its use is also envisaged in other sports involving throwing, or kicking a ball along a trajectory towards a goal, for example, in sports such as netball, football, or rugby.

1. A method for providing an enhanced sports training experience, comprising:
providing a user with a wearable near-eye display;
capturing an image in a user's field of vision;
detecting the presence of a basketball hoop in the image, the basketball hoop having an associated backboard;
using an image processor to determine a three dimensional position of the hoop relative to the near-eye display;
calculating an ideal trajectory between the user and the hoop, whereby a basketball following the trajectory will pass through the basketball hoop;
determining the apex of the trajectory; and
displaying on the near-eye display, a visual graphic at the trajectory apex, the visual graphic representing a target.

2. A method as claimed in claim 1, wherein the basketball hoop comprises a backboard with a graphic pattern, and the step of detecting the presence of a basketball hoop comprises detecting the graphic pattern.

3. A method as claimed in claim 1, wherein the step of determining the three dimensional position of the hoop comprises calculating the distance between the user and the hoop.

4. A method as claimed in claim 1, wherein the ideal trajectory is a trajectory whereby a basketball following the trajectory will pass through the basketball hoop without touching the backboard or the hoop.

5. A method as claimed in claim 1, wherein the visual graphic representing the target comprises a shape centred on the highest point of the trajectory.

6. A method as claimed in claim 5, wherein the shape is displayed in a vertical plane.

7. A method as claimed in claim 5, wherein the shape is a circle.

8. A method as claimed in claim 1, wherein the near-eye display comprises an augmented reality headset, and the image representing a target is overlaid on the user's field of vision.

9. A method as claimed in claim 1, wherein the near-eye display comprises a virtual reality headset.

10. A method as claimed in claim 1, further comprising the step of displaying the trajectory on the near-eye display.

11. A method as claimed in claim 1, comprising a camera continuously capturing an image in a user's field of vision, and wherein each time the image changes, the ideal trajectory is recalculated and the target re-adjusted.

12. A method as claimed in claim 1, comprising detecting movement of the user, and wherein each time movement is detected, the ideal trajectory is recalculated and the target re-adjusted.

13. A personal near-eye display apparatus for use during a sporting activity, comprising:
a camera for capturing an image in a user's field of vision;
one or more processors having access to non-transitory memory and configured to execute software for detecting the presence of a basketball hoop in the image, the software being configured to determine a 3D position of the hoop, calculate an ideal trajectory between the user and the hoop, whereby a basketball following the trajectory will pass through the basketball hoop, and determine an apex of the trajectory; and
a projector to display a graphic on the near-eye display at the trajectory apex, the visual graphic representing a target.

14. A near-eye display apparatus as claimed in claim 13, wherein the software is configured to detect a basketball hoop backboard that comprises a known graphic pattern.

15. A near-eye display apparatus as claimed in claim 13, wherein the software is configured to calculate the distance between the user and the hoop.

16. A near-eye display apparatus as claimed in claim 13, wherein the ideal trajectory is a trajectory whereby a basketball following the trajectory will pass through the basketball hoop without touching the backboard or the hoop.

17. A near-eye display apparatus as claimed in claim 13, wherein the visual graphic representing the target comprises a shape centred on the highest point of the trajectory.

18. A near-eye display apparatus as claimed in claim 17, wherein the projector displays the shape in a vertical orientation.

19. A near-eye display apparatus as claimed in claim 17, wherein the shape is a circle.

20. A near-eye display apparatus as claimed in claim 13, wherein the near-eye display comprises an augmented reality headset.

21. A near-eye display apparatus as claimed in claim 13, wherein the near-eye display comprises a virtual reality headset.

22. A near-eye display apparatus as claimed in claim 13, wherein the camera is configured to continuously capture an image in a user's field of vision, and wherein the processor is configured to detect changes to the image and recalculate the ideal trajectory adjust the target when a change is detected.

23. A system for use during a sporting activity, comprising:
a power source
a camera arranged to capture an image in a user's field of vision;
one or more processors having access to non-transitory storage and configured to execute software to detect presence of a basketball hoop in the image, to determine a three dimensional position of the hoop, calculate an ideal trajectory between the user and the hoop whereby a basketball following the trajectory will pass through the basketball hoop, and determine an apex of the trajectory; and
a wearable near-eye display apparatus having a projector configured to display a graphic on the near-eye display at the trajectory apex, the visual graphic representing a target.

24. A system as claimed in claim 23, further comprising a basketball hoop backboard having a known graphic pattern, wherein the software is configured to detect the presence of the hoop comprises by detecting the graphic pattern.

25. A system as claimed in claim 23, wherein the ideal trajectory is a trajectory whereby a basketball following the trajectory will pass through the basketball hoop without touching the backboard or the hoop.

26. A system as claimed in claim 23, wherein the visual graphic representing the target comprises a shape centred on the highest point of the trajectory.

27. A system as claimed in claim 23, wherein the near-eye display comprises an augmented reality headset or a virtual reality headset.

28. A system as claimed in claim 23, further comprising a user interface for controlling operation of the system.

29. Non transitory storage media comprising instructions for execution by a processor to provide an image on a wearable near-eye display, comprising:
obtaining and analysing an image in a user's field of vision;
detecting the presence of a basketball hoop in the image;
determining the three dimensional position of the hoop relative to a user;
calculating an ideal trajectory between the user and the hoop, whereby a basketball following the trajectory will pass through the basketball hoop;
determining the apex of the trajectory; and
displaying on the near-eye display, a visual graphic at the trajectory apex, the visual graphic representing a target.

30. Non transitory storage media as claimed in claim 29, wherein detecting the presence of a basketball hoop comprises detecting a known graphic on a backboard of the basketball hoop.

31. Non transitory storage media as claimed in claim 30, wherein the storage media comprises stored information about one or more known graphics for display on the backboard.

32. Non transitory storage media as claimed in claim 29, wherein calculating the ideal trajectory comprises calculating a trajectory whereby a basketball following the trajectory will pass through the basketball hoop without touching the backboard or the hoop.
